(19) United States
(12) Patent Application Publication
(10) Pub. No.: US 2010/0207503 A1
(43) Pub. Date: Aug. 19, 2010

(54) LIGHT SOURCE DEVICE, PROJECTOR, AND METHOD FOR MANUFACTURING LIGHT SOURCE DEVICE

(75) Inventors: Akira Egawa, Shiojiri-shi (JP); Kaname Nagatani, Matsumoto-shi (JP); Kunihiko Takagi, Okaya-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 12/696,607

(22) Filed: Jan. 29, 2010

(30) Foreign Application Priority Data
Feb. 19, 2009 (JP) 2009-036261

(51) Int. Cl. H01K 1/30; H01J 9/24

(52) U.S. Cl. 313/111; 313/114; 445/26

(57) ABSTRACT

A light source device includes: an arc tube having a light emitting portion that emits light; a sub-reflection mirror that covers a part of the periphery of the light emitting portion and reflects the light emitted from the light emitting portion; a main reflection mirror that reflects the light emitted from the light emitting portion and the light reflected by the sub-reflection mirror; and a base that is formed separately from the main reflection mirror and to which the main reflection mirror is secured, wherein an arc tube securing portion for positioning and securing the arc tube is formed in the base.

### BACKGROUND

1. Technical Field

The present invention relates to a light source device, a projector, and a method for manufacturing a light source device, and more particularly to a technique for a light source device having a reflector.

2. Related Art

In a lamp used as a light source of a projector, for example, a discharge lamp such as an extra-high pressure mercury lamp, a reflector (reflection mirror) that reflects light emitted from an arc tube is used. In order to effectively obtain a bright image from a projector, a configuration of a light source device has been proposed for enhancing the use efficiency of light emitted from an arc tube. For example, a technique of providing a sub-reflection mirror that covers a part of an arc tube, separately from a reflector as a main reflection mirror, has been proposed (for example, refer to JP-A-2001-109068). Light reflected by the sub-reflection mirror passes through the arc tube, is incident on the main reflection mirror, and then reflected forward. Thus, the light emitted from the arc tube can be effectively directed toward an optical system that utilizes the light from the light source device, and in addition, the light source device can be made thin.

However, as a light source device is made thinner, a space for accommodating an arc tube becomes smaller. When the space for accommodating the arc tube becomes smaller, there arises a problem that the securing work of the arc tube is difficult in assembly steps of the light source device. Further, when the securing work of the arc tube is carried out in the small space, the accuracy of positioning of the arc tube or the like becomes poor, which leads to a drop in yield.

### SUMMARY

An advantage of some aspects of the invention is to provide a light source device that can facilitate the work of securing an arc tube in assembly steps of the light source device and enhance the accuracy of positioning of the arc tube or the like to thereby prevent a drop in yield, a projector using the light source device, and a method for manufacturing a light source device.

A first aspect of the invention is directed to a light source device including: an arc tube having a light emitting portion that emits light; a sub-reflection mirror that covers a part of the periphery of the light emitting portion and reflects the light emitted from the light emitting portion; a main reflection mirror that reflects the light emitted from the light emitting portion and the light reflected by the sub-reflection mirror; and a base that is formed separately from the main reflection mirror and to which the main reflection mirror is secured, wherein an arc tube securing portion for positioning and securing the arc tube is formed in the base.

Since the main reflection mirror is formed separately from the base, and the securing work of the arc tube can be carried out on the base not covered with the main reflection mirror, the workability can be enhanced. Since the arc tube securing portion is formed in the base, securing of the arc tube can be facilitated, and the positioning accuracy can be enhanced. Thus, a drop in yield can be prevented. Further, by enhancing the positioning accuracy of the arc tube, light from the light emitting portion can be effectively extracted.

It is preferable that the main reflection mirror have substantially the same shape as a curved surface obtained by cutting a surface of revolution that is obtained by rotating a predetermined curve around a central axis along a predetermined plane, and that the sub-reflection mirror be disposed on a side of the light emitting portion opposite to a side where the main reflection mirror is disposed. Thus, a light source device that is thin and can effectively emit light is provided.

It is preferable that a main reflection mirror restricting portion for positioning the main reflection mirror be formed in the base. Since the main reflection mirror restricting portion is formed in the base, the positioning accuracy of the main reflection mirror can be enhanced. Thus, a drop in yield can be prevented.

It is preferable that a sub-reflection mirror securing portion for positioning and securing the sub-reflection mirror be formed in the base. Since the sub-reflection mirror securing portion is formed in the base, securing of the sub-reflection mirror is facilitated, and the positioning accuracy can be enhanced. Thus, a drop in yield can be prevented. Since the sub-reflection mirror is formed separately from the base, the sub-reflection mirror and the base can be formed of different materials that are suitable for respective characteristics. For example, the sub-reflection mirror that is required to accurately reflect light can use a material with which the shape is easily formed accurately, while the base can use another material.

It is preferable that the base and the sub-reflection mirror be formed integrally with each other. Since the base and the sub-reflection mirror are formed integrally with each other, a step of securing the sub-reflection mirror to the base can be omitted in assembly steps of the light source device, which can reduce the manufacturing cost.

A second aspect of the invention is directed to a projector including: the light source device according to the first aspect of the invention; and a spatial light modulator that modulates light emitted from the light source device according to an image signal. The use of the light source device can reduce the manufacturing cost of light source device, so that the manufacturing cost of the projector can be reduced. Further, by effectively extracting light from the light emitting portion, a projector that can display an image with high luminance is provided.

A third aspect of the invention is directed to a method for manufacturing a light source device including an arc tube having a light emitting portion that emits light, a sub-reflection mirror that covers a part of the periphery of the light emitting portion and reflects the light emitted from the light emitting portion, and a main reflection mirror that reflects the light emitted from the light emitting portion and the light reflected by the sub-reflection mirror, including: securing the arc tube to an arc tube securing portion for positioning and securing the arc tube, the arc tube securing portion being formed in a base that is formed separately from the main reflection mirror; and securing the main reflection mirror to the base.

The arc tube and the like are sequentially secured to the base on the basis of the base, so that the light source device is assembled. Since the base is formed separately from the main reflection mirror, and the securing work of the arc tube can be carried out on the base not covered with the main reflection mirror, the workability of the assembly steps of the light source device can be enhanced.

When the arc tube is secured to the arc tube securing portion formed in the base, the position of the arc tube in the light source device is determined. Therefore, the positioning of the arc tube can be easily carried out accurately. Since the positions of the arc tube and the main reflection mirror in the light source device are determined on the basis of the base as a single member, the positioning accuracy can be improved. Improvement in positioning accuracy enables the positional relationship between the arc tube and the main reflection mirror to be appropriate, so that light from the light emitting portion can be effectively extracted. Simplified positioning and improvement in accuracy can prevent a drop in yield of the light source device, which can reduce the manufacturing cost.

It is preferable that the method further include securing the sub-reflection mirror to a sub-reflection mirror securing portion for positioning and securing the sub-reflection mirror, the sub-reflection mirror securing portion being formed in the base. When the sub-reflection mirror is secured to the sub-reflection mirror securing portion formed in the base, the position of the sub-reflection mirror in the light source device is determined. Therefore, the positioning of the sub-reflection mirror can be easily carried out accurately.

### BRIEF DESCRIPTION OF THE DRAWINGS

The invention will be described with reference to the accompanying drawings, wherein like numbers reference like elements.

FIG. 1 is an appearance perspective view showing a schematic configuration of a light source device according to a first embodiment of the invention.

FIG. 2 is a transverse cross-sectional view of the light source device.

FIG. 3 is an exploded perspective view of the light source device.

FIGS. 4A to 4C are explanatory views of assembly steps of the light source device.

FIG. 4D is a flowchart for explaining the steps.

FIG. 5 is a transverse cross-sectional view showing a schematic configuration of a light source device according to a second embodiment of the invention.

FIG. 6 shows a schematic configuration of a projector according to a third embodiment of the invention.

### DESCRIPTION OF EXEMPLARY EMBODIMENTS

Hereinafter, embodiments of the invention will be described in detail with reference to the drawings.

### First Embodiment

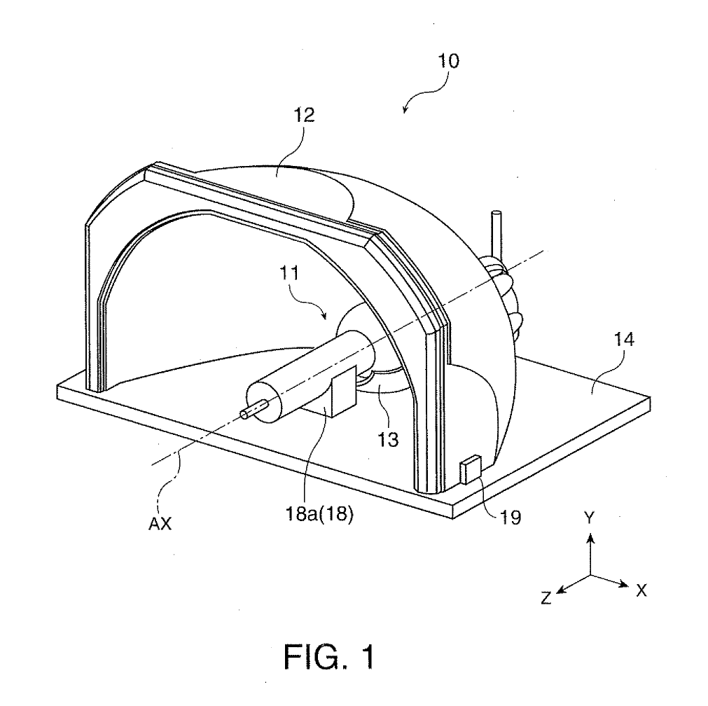

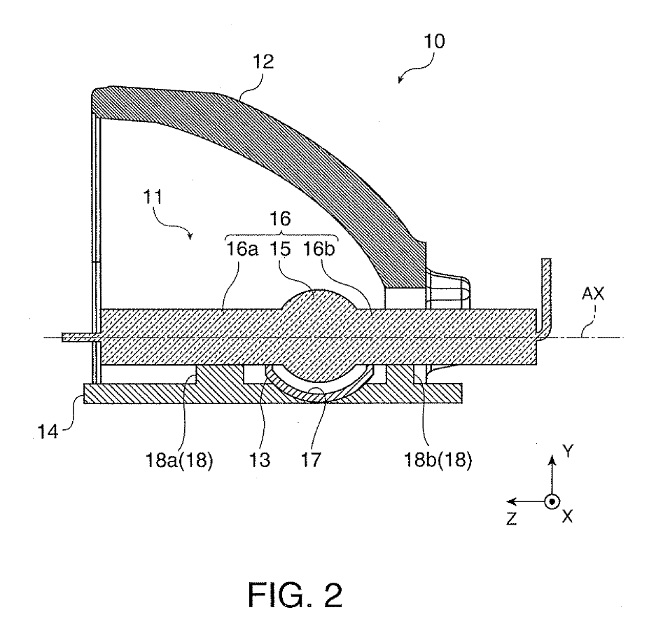

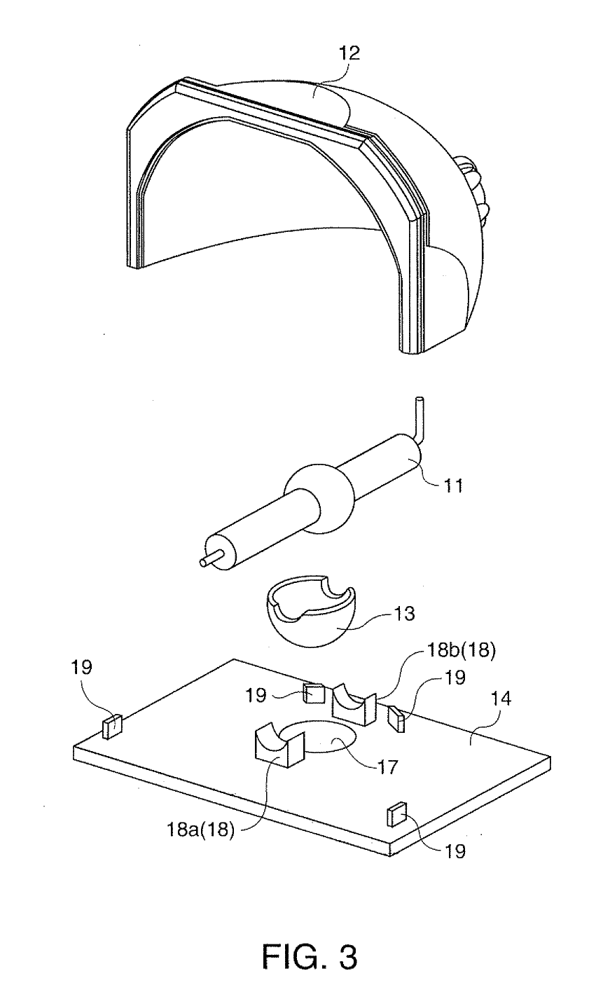

FIG. 1 is an appearance perspective view showing a schematic configuration of a light source device 10 according to a first embodiment of the invention. FIG. 2 is a transverse cross-sectional view of the light source device 10 shown in FIG. 1. FIG. 3 is an exploded perspective view of the light source device 10. In the description of the embodiments of the invention, an axis along an emitting direction of light from the light source device 10 is defined as a Z-axis. Axes that are perpendicular to the Z-axis and intersect at right angles to each other are an X-axis and a Y-axis. A direction of arrow in each of the axes is defined as a positive direction, while the opposite direction is defined as a negative direction. For example, an arc tube 11 is an extra-high pressure mercury lamp. An envelope 16 seals the inside of the arc tube 11. For example, a quartz material is used for the envelope 16. A bulbous portion of the envelope 16 interposed between a front sealing portion 16a and a rear sealing portion 16b is a light emitting portion 15 that emits light. A discharge space in which a pair of electrodes are disposed is formed inside the light emitting portion 15. The front sealing portion 16a is a cylindrical portion of the arc tube 11 disposed on the front side of the light emitting portion 15. The rear sealing portion 16b is a cylindrical portion of the arc tube 11 disposed on the rear side of the light emitting portion 15. The “front side” means an emitting side of the light from the light source device 10, while the “rear side” means a side of the light emitting portion 15 opposite to the front.

A main reflection mirror 12 reflects light emitted from the light emitting portion 15 and light reflected by a sub-reflection mirror 13 and directs them toward the front side. The main reflection mirror 12 has substantially the same shape as a curved surface obtained by cutting an ellipsoid of revolution that is obtained by rotating an ellipse about a central axis AX along a predetermined plane. The arc tube 11 is disposed on the central axis AX. In the embodiment, the predetermined plane is a plane including the central axis AX. The predetermined plane may be a plane other than that including the central axis AX in order to improve light use efficiency. For example, the predetermined plane may be a plane parallel to the central axis AX or a plane tilted with respect to the central axis AX.

The main reflection mirror 12 is formed by depositing a highly reflective material, for example, a dielectric multilayer film or a metal material on the surface of a substrate molded into a desired shape. As a highly reflective material, a material with a high reflectivity with respect to light having a wavelength in the visible region is used. By using the main reflection mirror 12 having the shape obtained by cutting an ellipsoid of revolution, the light source device 10 can be made thin. The shape of the main reflection mirror 12 is not limited to the shape that is substantially the same as the curved surface obtained by cutting an ellipsoid of revolution. For example, the main reflection mirror 12 may have a shape that is substantially the same as a curved surface obtained by cutting a surface of revolution obtained by rotating a predetermined curve such as a parabola, or a free curved surface shape.

The sub-reflection mirror 13 reflects light emitted from the light emitting portion 15 toward the light emitting portion 15. The sub-reflection mirror 13 covers a portion of the periphery of the light emitting portion 15 on a side of the light emitting portion 15 opposite to a side where the main reflection mirror 12 is disposed. A gap is formed between the sub-reflection mirror 13 and the light emitting portion 15. For example, a quartz material is used for a substrate of the sub-reflection mirror 13. The sub-reflection mirror 13 is formed by depositing a highly reflective material, for example, a dielectric multilayer film or a metal material on the surface of the substrate molded into a desired shape. As a highly reflective material, a material with a high reflectivity with respect to light having a wavelength in the visible region is used. By disposing the main reflection mirror 12 and the sub-reflection mirror 13, light emitted from the light emitting portion can be effectively directed toward an optical system that utilizes light from the light source device 10.

A base 14 is formed separately from the main reflection mirror 12 and disposed on the opposite side from the main reflection mirror 12 with the arc tube 11 interposed therebetween. A sub-reflection mirror securing hole (sub-reflection mirror securing portion) 17 for securing the sub-reflection mirror 13 is formed through the base 14. The sub-reflection mirror securing hole 17 has substantially the same shape as that of the outer surface of the sub-reflection mirror 13. The sub-reflection mirror 13 is bonded to the sub-reflection mirror securing hole 17, thereby being secured to the base 14. As an adhesive for bonding the sub-reflection mirror 13 to the base 14, a cement, a ceramic system adhesive, or the like is used, for example.

An arc tube securing portion 18 for securing the arc tube 11 is formed in the base 14. The arc tube securing portion 18 includes a front supporting portion 18a and a rear supporting portion 18b. The front supporting portion 18a supports the front sealing portion 16a of the arc tube 11. The rear supporting portion 18b supports the rear sealing portion 16b of the arc tube 11. The arc tube 11 is secured to the base 14 with the front sealing portion 16a and the rear sealing portion 16b being bonded to the front supporting portion 18a and the rear supporting portion 18b, respectively. As an adhesive for bonding the arc tube 11 to the base 14, a cement, a ceramic system adhesive, or the like is used, for example.

The main reflection mirror 12 is secured to the base 14. Main reflection mirror restricting portions 19 for positioning the main reflection mirror 12 upon securing the main reflection mirror 12 are formed in the base 14. The main reflection mirror 12 is secured such that the outer surface thereof is brought into contact with the main reflection mirror restricting portions 19, thereby being disposed at a proper position. The main reflection mirror 12 may be secured by bonding to the base 14 by using an adhesive, or the main reflection mirror 12 may be secured with the main reflection mirror restricting portions 19 being engaged therewith.

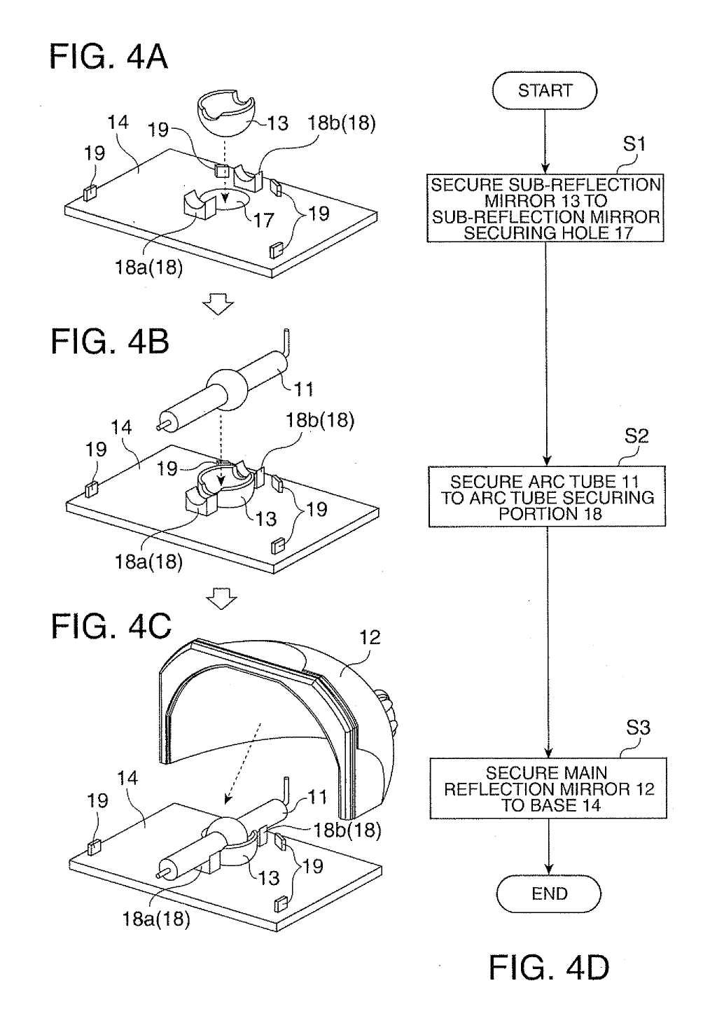

FIGS. 4A to 4C are explanatory views of assembly steps (manufacturing method) of the light source device 10. FIG. 4D is a flowchart for explaining the steps. First, the sub-reflection mirror 13 is secured to the sub-reflection mirror securing hole 17 of the base 14 (Step S1). Next, the arc tube 11 is secured to the arc tube securing portion 18 of the base 14 (Step S2). Next, the main reflection mirror 12 is secured to the base 14 such that the outer side of the main reflection mirror 12 is brought into contact with the main reflection mirror restricting portions 19 of the base 14 (Step S3).

As described above, the sub-reflection mirror 13 and the like are sequentially secured to the base 14 on the basis of the base 14, so that the light source device 10 is assembled. The base 14 is formed separately from the main reflection mirror 12. In addition, the sub-reflection mirror 13 or the arc tube 11 can be secured before securing the main reflection mirror 12. Therefore, work can be carried out in a wide space not covered with the main reflection mirror 12. Thus, the workability of the assembly steps of the light source device 10 can be enhanced.

When the sub-reflection mirror 13 and the arc tube 11 are respectively secured to the sub-reflection mirror securing hole 17 and the arc tube securing portion formed in the base 14, the positions of the sub-reflection mirror 13 and the arc tube 11 in the light source device 10 are determined. Therefore, the positioning of each of the members can be easily performed.

Since the positions of the sub-reflection mirror 13, the arc tube 11, and the main reflection mirror 12 in the light source device 10 are determined on the basis of the base 14 as a single member, the accuracy of positioning can be improved. Improvement in accuracy of positioning enables the positional relationship among the arc tube 11, the main reflection mirror 12, and the sub-reflection mirror 13 to be appropriate, so that light from the arc tube 11 can be effectively extracted. Simplified positioning and improvement in accuracy can prevent a drop in yield of the light source device 10, which can reduce the manufacturing cost.

Since the sub-reflection mirror 13 is formed separately from the base 14, the sub-reflection mirror 13 and the base 14 can be formed of different materials that are suitable for respective characteristics. For example, the sub-reflection mirror 13 that is required to accurately reflect light can use a material with which the shape is easily formed accurately, while the base 14 can use another material.

In the first embodiment, although the main reflection mirror restricting portion 19 for positioning the main reflection mirror 12 is formed in the base 14 in an erected manner, this is not restrictive. For example, a groove into which the edge of the main reflection mirror 12 is fit may be formed in the base 14.

### Second Embodiment

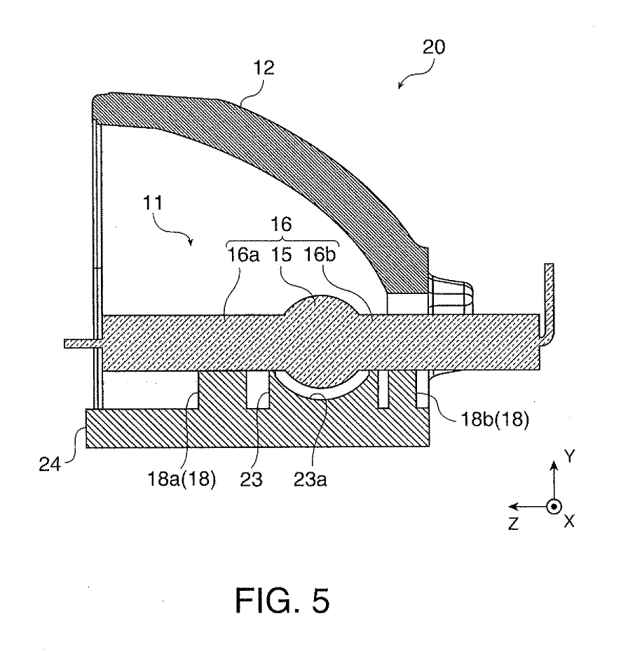

FIG. 5 is a transverse cross-sectional view showing a schematic configuration of a light source device 20 according to a second embodiment of the invention. The same portions as in the first embodiment are denoted by the same reference numerals, and the repetitive description thereof is omitted. In the light source device 20 according to the second embodiment, a sub-reflection mirror 23 is integrally formed with a base 24. Similarly to the first embodiment, the arc tube securing portion 18 and the main reflection mirror restricting portions (not shown) are formed in the base 24. The sub-reflection mirror 23 is integrally formed with the base 24 and formed by depositing a highly reflective material, for example, a dielectric multilayer film or a metal material on a reflecting surface 23a that covers the light emitting portion 15. As a highly reflective material, a material with a high reflectivity with respect to light having a wavelength in the visible region is used.

As described above, since the sub-reflection mirror 23 is integrally formed with the base 24, a step of securing the sub-reflection mirror 23 to the base 24 (corresponding to Step S1 in FIG. 4D) can be omitted in assembly steps of the light source device 20. Thus, the manufacturing cost of the light source device 20 can be reduced.

### Third Embodiment

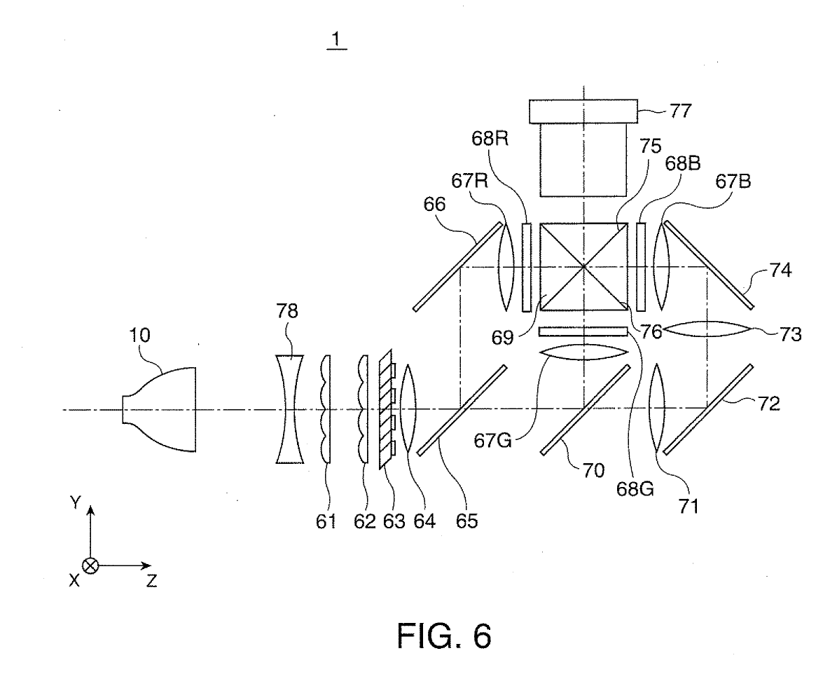

FIG. 6 shows a schematic configuration of a projector 1 according to a third embodiment of the invention. The projector 1 is a front projection type projector that projects light on a not-shown screen and presents an image to the viewer who observes the light reflected by the screen. The projector 1 has the light source device 10 according to the first embodiment. In this case, the light source device 10 is shown as viewed from the positive direction side along the Y-axis in the configuration shown in FIG. 1.

The light source device 10 emits light including red (R) light, green (G) light, and blue (B) light. A concave lens 78 parallelizes the light emitted from the light source device 10. A first integrator lens 61 and a second integrator lens 62 each have a plurality of lens elements arranged in an array. The first integrator lens 61 divides a luminous flux from the concave lens 78 into a plurality of luminous fluxes. Each lens element of the first integrator lens 61 condenses the luminous flux from the concave lens 78 near the lens element of the second integrator lens 62. The lens element of the second integrator lens 62 forms an image of the lens element of the first integrator lens 61 on a spatial light modulator.

The light transmitted through the two integrator lenses 61 and 62 is converted into linearly polarized light in a specific oscillating direction by a polarization conversion element 63. A superimposing lens superimposes an image of each lens element of the first integrator lens 61 on the spatial light modulator. The first integrator lens 61, the second integrator lens 62, and the superimposing lens 64 make the intensity distribution of the light from the light source device 10 uniform on the spatial light modulator. The light from the superimposing lens 64 is incident on a first dichroic mirror 65. The first dichroic mirror 65 reflects R light and transmits G light and B light. An optical path of the R light incident on the first dichroic mirror 65 is bent at the first dichroic mirror 65 and a reflection mirror 66, and then the R light is incident on a field lens 67R for R light. The field lens 67R for R light parallelize the R light from the reflection mirror 66 and makes the R light incident on a spatial light modulator 68R for R light.

The spatial light modulator 68R for R light is a spatial light modulator that modulates R light according to an image signal, and is a transmissive liquid crystal display device. A not-shown liquid crystal panel provided in the spatial light modulator 68R for R light has a liquid crystal layer interposed between two transparent substrates in order to modulate light according to an image signal. The R light modulated by the spatial light modulator 68R for R light is incident on a cross dichroic prism 69 that is a light combining system.

The G light and the B light transmitted through the first dichroic mirror 65 are incident on a second dichroic mirror 70. The second dichroic mirror 70 reflects the G light and transmits the B light. An optical path of the G light incident on the second dichroic mirror 70 is bent at the second dichroic mirror 70, and then the G light is incident on a field lens 67G for G light. The field lens 67G for G light parallelizes the G light from the second dichroic mirror 70 and makes the G light incident on a spatial light modulator 68G for G light. The spatial light modulator 68G for G light is a spatial light modulator that modulates G light according to an image signal, and is a transmissive liquid crystal display device. The G light modulated by the spatial light modulator 68G for G light is incident on a surface of the cross dichroic prism 69 different from the surface on which the R light is incident.

The B light transmitted through the second dichroic mirror 70 transmits through a relay lens 71, and then the optical path thereof is bent by the reflection at a reflection mirror 72. The B light from the reflection mirror 72 further transmits through a relay lens 73, and then the optical path thereof is bent by the reflection at a reflection mirror 74. Thereafter, the B light is incident on a field lens 67B for B light. Since the optical path of B light is longer than those of R light and G light, a relay system that uses the relay lenses 71 and 73 is adopted in the optical path of B light in order to make an illumination rate in the spatial light modulator for B light equal to those for lights of the other colors.

The field lens 67B for B light parallelizes the B light from the reflection mirror 74 and makes the B light incident on a spatial light modulator 68B for B light. The spatial light modulator 68B for B light is a spatial light modulator that modulates B light according to an image signal, and is a transmissive liquid crystal display device. The B light modulated by the spatial light modulator 68B for B light is incident on a surface of the cross dichroic prism 69 different from the surface on which R light is incident and the surface on which G light is incident.

The cross dichroic prism 69 has two dichroic filters 75 and 76 that are substantially perpendicular to each other. The first dichroic filter 75 reflects the R light and transmits the G light and the B light. The second dichroic filter 76 reflects the B light and transmits the R light and the G light. The cross dichroic prism 69 combines the R light, the G light, and the B light incident from different directions and then emits the combined light in a direction of a projection lens 77. The projection lens 77 projects the light combined by the cross dichroic prism 69 toward a direction of the screen.

The projector 1 uses the light source device 10, thereby being able to effectively extract light from the arc tube 11 (refer to FIG. 1). Thus, an effect that the projector 1 capable of displaying an image with high luminance can be obtained is provided. In addition, reducing the manufacturing cost of the light source device 10 can contribute to a reduction in manufacturing cost of the projector 1 itself. The projector 1 may use any of the light source devices in the embodiments.

The projector 1 does not necessarily use a transmissive liquid crystal display device as a spatial light modulator. As a spatial light modulator, a reflective liquid crystal display device (Liquid Crystal On Silicon; LCOS), a DMD (Digital Micromirror Device), a GLV (Grating Light Valve), or the like may be used. The projector 1 does not necessarily include a spatial light modulator for each color light. The projector 1 may include one spatial light modulator that modulates two, three, or more color lights. The projector 1 does not necessarily use a spatial light modulator. The projector 1 may be a slide projector using slides carrying image information. The projector 1 may be so-called a rear projector that supplies light on one side of a screen and presents an image to the viewer who observes the light that is emitted from the other side of the screen.

As described above, the light source device according to the invention is suitably used for a projector.

The entire disclosure of Japanese Patent Application No: 2009-036261, filed Feb. 19, 2009 is expressly incorporated by reference herein.

What is claimed is:

1. A light source device comprising:
an arc tube having a light emitting portion that emits light;
a sub-reflection mirror that covers a part of the periphery of the light emitting portion and reflects the light emitted from the light emitting portion;
a main reflection mirror that reflects the light emitted from the light emitting portion and the light reflected by the sub-reflection mirror;
a base that is formed separately from the main reflection mirror and to which the main reflection mirror is secured; and
an arc tube securing portion for positioning and securing the arc tube, the arc tube securing portion being formed in the base.

2. The light source device according to claim 1, wherein
the main reflection mirror has substantially the same shape as a curved surface obtained by cutting a surface of revolution that is obtained by rotating a predetermined curve around a central axis along a predetermined plane, and
the sub-reflection mirror is disposed on a side of the light emitting portion opposite to a side where the main reflection mirror is disposed.

3. The light source device according to claim 1, further comprising a main reflection mirror restricting portion for positioning the main reflection mirror, the main reflection mirror restricting portion being formed in the base.

4. The light source device according to claim 1, further comprising a sub-reflection mirror securing portion for positioning and securing the sub-reflection mirror, the sub-reflection mirror securing portion being formed in the base.

5. The light source device according to claim 1, wherein
the base and the sub-reflection mirror are formed integrally with each other.

6. A projector comprising:
the light source device according to claim 1; and
a spatial light modulator that modulates light emitted from the light source device according to an image signal.

7. A method for manufacturing a light source device including an arc tube having a light emitting portion that emits light, a sub-reflection mirror that covers a part of the periphery of the light emitting portion and reflects the light emitted from the light emitting portion, and a main reflection mirror that reflects the light emitted from the light emitting portion and the light reflected by the sub-reflection mirror, comprising:
securing the arc tube to an arc tube securing portion for positioning and securing the arc tube, the arc tube securing portion being formed in a base that is formed separately from the main reflection mirror; and
securing the main reflection mirror to the base.

8. The method for manufacturing the light source device according to claim 7, further comprising securing the sub-reflection mirror to a sub-reflection mirror securing portion for positioning and securing the sub-reflection mirror, the sub-reflection mirror securing portion being formed in the base.
